(19) United States
(12) Patent Application Publication
(10) Pub. No.: US 2024/0220296 A1
(43) Pub. Date: Jul. 4, 2024

(54) SECURE MEMORY-MAPPED INPUT/OUTPUT

(71) Applicants: ATI TECHNOLOGIES ULC, MARKHAM (CA); ADVANCED MICRO DEVICES, INC., Santa Clara (CA)

(72) Inventors: Philip Ng, Toronto (CA); Nippon Raval, Markham (CA); Jeremy W. Powell, Austin, TX (US); Donald Matthews, JR., Ft. Collins, CO (US); David Kaplan, Austin, TX (US)

(21) Appl. No.: 18/090,605

(22) Filed: Dec. 29, 2022

(51) Int. Cl. G06F 9/455; G06F 12/1081

(52) U.S. Cl. CPC G06F 9/45558; G06F 12/1081; G06F 2009/45587

(57) ABSTRACT

A processor manages memory-mapped input/output (MMIO) accesses, in secure fashion, at an input/output memory management unit (IOMMU). The processor is configured to ensure that, for a given MMIO request issued by a processor core and associated with a particular executing VM, the request is targeted to a MMIO address that has been assigned to the VM by a security module (e.g., a security co-processor). The processor thus prevents a malicious entity from accessing confidential information of a VM via MMIO requests.

### BACKGROUND

In a confidential computing environment, a processing system (e.g., a server) executes multiple software programs, such as virtual machines and a virtual machine manager (e.g., a hypervisor), wherein different software programs are owned by different entities. For example, in some confidential computing environments, different virtual machines executed by the environment are owned by different companies. A virtual machine manager (e.g., a hypervisor) controls the scheduling of the different virtual machines for execution and provides an interface between the virtual machines and the server hardware, so that each virtual machine (VM) is able to operate as if that VM were executing on its own dedicated hardware.

Because the different VMs are often owned by different entities, some confidential computing systems support security features that prevent one VM from accessing the data or other information associated with another VM. However, in some cases the confidential information of a VM is accessible via input/output devices that interact with the VM, either directly or by observing the behavior of the VM in response to activity by the input/output devices.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that employs an input/output memory management unit (IOMMU) to manage secure memory mapped input/output (MMIO) in accordance with some embodiments.

FIG. 2 is a block diagram of an example mapping table employed by the IOMMU of FIG. 1 to manage secure MMIO requests in accordance with some embodiments.

FIG. 3 is a block diagram illustrating an example of the IOMMU of FIG. 1 preventing execution of an MMIO request associated with a virtual machine when the MMIO request is targeted to a memory address outside of a specified range in accordance with some embodiments.

FIG. 4 is a block diagram illustrating an example of the IOMMU of FIG. 1 managing MMIO accesses for multiple virtual machines in accordance with some embodiments.

FIG. 5 is a flow diagram of a method of managing secure MMIO accesses at an IOMMU in accordance with some embodiments.

### DETAILED DESCRIPTION

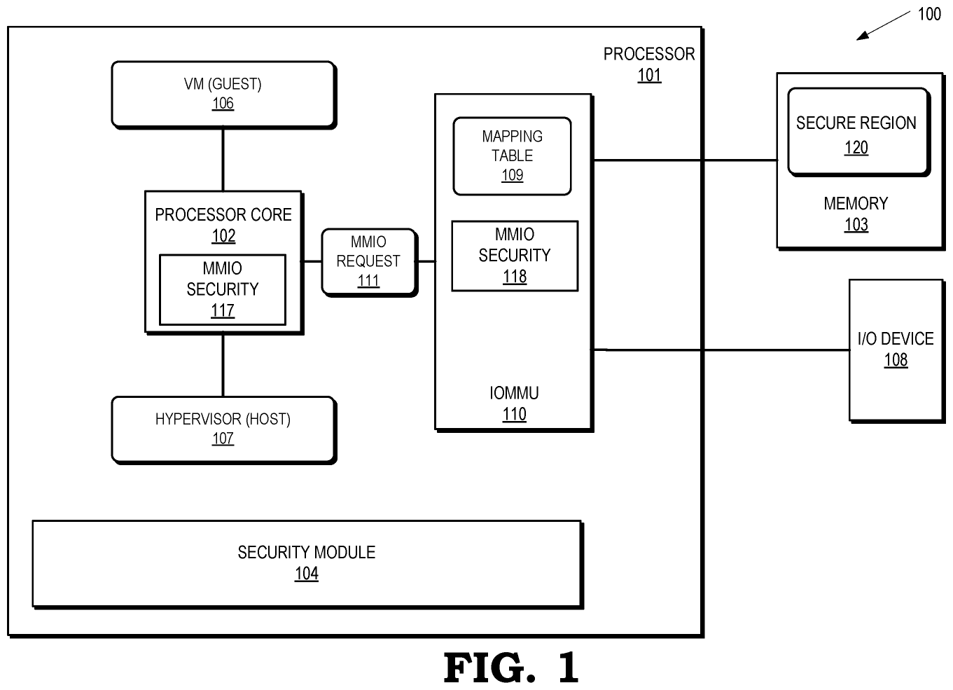

FIGS. 1-5 illustrate techniques for managing MMIO accesses, in secure fashion, at a processing system in accordance with some embodiments. A processor including an input/output memory management unit (IOMMU) is configured to ensure that, for a given MMIO request issued by processor core and associated with a particular executing VM, the request is targeted to a MMIO address that has been assigned to the VM by a security module (e.g., a security co-processor). The processor thus prevents a malicious entity from accessing confidential information of a VM via MMIO requests.

To illustrate further via an example, in some processing systems a processor core accesses I/O devices are by issuing MMIO requests, wherein each MMIO request identifies a memory address from which data is to be read, a memory address to which data is to be written, or a combination thereof. For example, in some cases the processor core programs a particular register of an I/O device by issuing an MMIO request to write data to a memory address associated with the register. By using memory addresses to provide information to, or retrieve information from, an I/O device, the processor core is able to interact with the I/O device using a relatively simple set of access commands, and by leveraging at least some hardware used to access system memory, thereby improving overall efficiency of the processor core. To enhance processing efficiency an IOMMU of the processing system assists in execution of the MMIO requests. However, in at least some cases the MMIO requests render secure data of the processing system vulnerable to unauthorized access or modification. For example, a malicious entity could employ an MMIO request to program a register or other portion of an I/O device that is assigned to an executing VM, thereby accessing confidential information. As another example, the malicious entity could employ an MMIO request to write data to a register of an I/O device assigned to the executing VM, requiring the VM to take remedial action that exposes the behavior of the VM to unauthorized examination.

To prevent these and similar attacks by a malicious entity, a processing system, using the techniques described herein, employs security hardware to ensure that each MMIO request associated with a VM is targeted to a memory that has been assigned to the VM. For example, in some embodiments, a security module (e.g., a security co-processor) of the processing system implements a specified device binding process (e.g., a Trusted Execution Environment (TEE) Device Interface Secure Protocol (TDISP) process) that binds an I/O device to a VM. The binding process implements specified processes, such as an authentication process, which allows the VM to “trust” the I/O device—that is, to assume that the operations of the I/O device are secure and unlikely to result in exposure of confidential VM information. In addition, the security module assigns, to each executing VM, a corresponding memory address space, corresponding to both a region of system memory, and a set of memory-mapped I/O devices where the VM is exclusively permitted to write or read data.

In response to receiving an MMIO request from a processor core, the IOMMU determines the VM associated with the request, such as by determining a VM identifier (VMID) from the MMIO request itself. The IOMMU then determines whether the MMIO request targets a memory address that is assigned to the VM by the security module. If not, the IOMMU prevents execution of the MMIO request as described herein, such as by preventing translation of the memory address to a physical address. If the memory address targeted by the MMIO request is assigned to the VM, the IOMMU executes the MMIO request. Thus, using the techniques described herein, an IOMMU prevents execution of an MMIO request on behalf of a VM when the MMIO request targets a memory address that is not assigned to the VM. The IOMMU thus prevents unauthorized access to, or modification of confidential information associated with a VM. Further, because these security operations are performed by the IOMMU itself, it is difficult for a hypervisor or other entity to interfere with those operations, thus supporting secure MMIO accesses in confidential computing environments.

FIG. 1 illustrates a processing system 100 in accordance with some embodiments. The processing system 100 is generally configured to execute sets of instructions (e.g., computer programs) to carry out tasks on behalf of an electronic device. Accordingly, in different embodiments the processing system 100 is part of any of a variety of electronic devices. For purposes of description, it is assumed that the processing system 100 is part of an electronic device that implements a confidential computing environment, such as a server. However, in other embodiments, the processing system 100 is part of a desktop computer, laptop computer, tablet, game console, and the like.

To implement the confidential computing environment, and to execute the sets of instructions and corresponding operations, the processing system 100 includes a processor 101, a memory 103, and one or more input/output (I/O) devices, such as I/O device 108. In some embodiments, the processor 101 is a general-purpose processor, such as a central processing unit (CPU) including hardware structures configured to retrieve and execute the sets of instructions. The memory 103 includes one or more memory devices configured to store and retrieve data based on commands (e.g., store and load commands) received from the processor 101. Accordingly, in different embodiments the memory 103 is random access memory (RAM), non-volatile memory (NVM), hard disc memory, and the like, or any combination thereof.

The I/O device 108 is any device that can, independent of the processor 101, process input information, output information, or a combination thereof on behalf of the processing system 100. For example, in some embodiments the I/O device 108 is a network interface device that processes input and output information for a network (not shown) connected to the processing system 100. In other embodiments, the I/O device 108 is a storage controller (e.g., a disc controller or non-volatile memory (NVM) storage controller), a controller associated with a user interface (e.g., a keyboard), and the like.

To execute the sets of instructions and corresponding operations, the processor 101 includes a processor core 102, a security module 104, and an input/output memory management unit. It will be appreciated that in some embodiments the processor 101 includes additional hardware to execute instructions, and to execute operations based on those instructions, such as additional processor cores, additional processing units (e.g., one or more graphics processing units), one or more controllers (e.g., memory controllers and input/output controllers), and the like.

The processor core 102 includes one or more instruction pipelines including a plurality of stages to execute instructions in a pipelined fashion. Thus, for example, in some embodiments an instruction pipeline of the processor core 102 includes a fetch stage, a decode stage, a dispatch stage, one or more execution stages (with one or more corresponding execution units), a retire stage, and the like. The processor core 102 also includes, or has access to, memory structures and other hardware (not explicitly illustrated at FIG. 1) that support execution of instructions. For example, in some embodiments the processor core 102 includes or has access to one or more cache structures to store data used for execution of the instructions.

The security module 104 is a set of hardware structures generally configured to create, monitor and maintain a security environment for the processor 101. For example, in at least some embodiments the security module 104 is configured to manage the boot process for the processor 101, initialize security related mechanisms for the processor 101, and monitoring the processing system 100 for suspicious activity or events and implement an appropriate response. In some embodiments the security module 104 includes a microcontroller, a cryptographic coprocessor (CCP) to encrypt and decrypt data, local memory and local registers to store, for example, cryptographic keys, and includes interfaces to interact with the memory 103, the I/O controller of the processor 101, and configuration registers of the processor 101. In some embodiments, the security module 104 includes Environment Management Control hardware that performs environmental and security checking to ensure that the processor 101 is operating according to specified security parameters.

In some embodiments, the security module 104 manages a device binding process, wherein an I/O device is bound to a VM by undergoing a specified security registration process. For example, in some embodiments the VM 106 seeks to bind the I/O device 108 by sending a binding request to the security module 104. In response, the security module 104 initiates the specified security registration process, such as by requesting authentication information (e.g., a device certificate) from the I/O device 108 and verifying the authentication information (e.g., by comparing the authentication information, or key information generated based on the authentication information, to one or more security keys). If the authentication information received from the I/O device 108 is verified, the security module 104 indicates to the VM 106, and to other components of the processor 101 as described further herein, that the I/O device 108 is bound to the VM 106.

It will be appreciated that, in some embodiments, an I/O device is able to be bound to multiple virtual machines by undergoing the specified security registration process for that VM. For example, in some embodiments each virtual machine employs a different virtual function (VF) to interact with a physical I/O device, thus allowing the I/O device to be virtualized as a different virtual I/O device for each VM. In some embodiments, the security module 104 binds an I/O device to a VM by binding the corresponding VF to the VM, thus allowing a single physical I/O device to be bound to multiple VMs (as long as the physical I/O device undergoes the security registration process for each VM).

As noted above, the processing system 100 is generally configured to implement a confidential computing environment, and in particular to execute a plurality of virtual machines (VMs) (e.g., VM 106), also referred to as guests, and a hypervisor 107, also referred to as a host, to manage execution of the plurality of VMs. Because the different VMs, and at least in some cases the hypervisor 107, are owned by different entities, the processing system 100 implements security features to protect the data of a given VM from access by other software, such as by another VM or by the hypervisor 107. For example, the processing system 100 implements data security for the VMs by implementing a secure region 120 of the memory 103 that stores encrypted data. In particular, the processor 101 is configured to encrypt specified data for each VM according to a corresponding private cryptographic key, and to store the encrypted data at the secure region 120. Because the data is encrypted, the data for one VM is protected from unauthorized access by other VMs and by the hypervisor 107. In at least some embodiments, cryptographic keys for the VMs are managed by the security module 104, and data encryption and decryption for the VMs is executed by a dedicated hardware encryption/decryption module (not shown) at a memory controller (not shown) of the processor 101.

To enhance processing efficiency, the IOMMU 110 is generally configured to perform specified memory access operations on behalf of the processor 101—that is, to perform memory access operations using dedicated hardware of the IOMMU 110, and without requiring management of the memory access operations by the processor 101. In particular, the IOMMU 110 includes dedicated hardware to perform MMIO operations, wherein processor cores (such as processor core 102), when executing a VM, generate MMIO requests (e.g., MMIO request 111) to read data from an I/O devices (e.g., the I/O device 108), write data to the I/O device, or a combination thereof. In some embodiments, each MMIO request indicates the virtual addresses of a register or other storage location of the I/O device to be accessed—that is, the virtual address of a register or other storage location from which data is to be read, the virtual address of a register or other storage location where data is to be written, or both. The IOMMU 110 is generally configured to interact with the I/O devices to carry out the one or more operations (read operations, write operations, or a combination thereof) indicated by the MMIO request.

Because the MMIO requests are, at least in some cases, executed independently of the operations of the processor 101, the MMIO requests provide an avenue for a malicious entity to access confidential information associated with VMs executing at the processor 101. For example, a malicious entity (or an I/O device that is controlled by a malicious entity) could issue an MMIO request targeting a register or storage location that has not been assigned to the VM 106 when the VM 106 is executing, thereby exposing confidential data of the VM 106 to unauthorized access, or triggering behavior by the VM 106 (e.g., to manage an I/O device that has been programmed by the malicious MMIO request) that can in turn expose confidential information to the malicious entity.

To address these potential vulnerabilities, the IOMMU 110 maintains a mapping table 109 that indicates, for each VM, a set of memory addresses that are assigned to the VM, including memory addresses associated with registers or other storage locations. Although in the example of FIG. 1 the mapping table 109 is illustrated as being part of the IOMMU 110, in some embodiments the mapping table 109 is stored at the secure region 120 of the memory 103, and the IOMMU 110 reads portions of the mapping table 109 from the secure region as needed in order to carry out the operations described further herein. Furthermore, in some embodiments the IOMMU 110 caches portions of the mapping table 109 to improve performance.

The mapping table 109 stores information, such as I/O device root port numbers (e.g., PCIe root port numbers), data stream identifiers (e.g., PCIe IDE Stream IDs), and MMIO address ranges that are used by the processor 101 to determine whether to allow execution of the MMIO request 111 as described further below. These determinations are performed by security hardware of the processor 101, and in particular security hardware (designated MMIO security 117) located at the processor core 102 and security hardware (designated MMIO security 118) located at the IOMMU 110. For purposes of description below, it is assumed that the security operations associated with the MMIO request are performed by the MMIO security 118 at the IOMMU 110. However, it will be appreciated that in other embodiments, one or more of the described security operations are performed by the MMIO security 117 at the processor 101.

To illustrate, in some embodiments, when execution of VM is initiated, the security module 104 determines the set of memory addresses that is to be assigned to the VM, including both memory addresses associated with the memory 103 and memory addresses associated with registers and other storage locations of I/O devices such as the I/O device 108. The security module 104 ensures that two VMs are not assigned the same portion (or overlapping portions) of a set of memory addresses. The security module 104 indicates the assigned memory addresses to the IOMMU 110, which stores information indicating the assigned portion (e.g., by storing a set of memory addresses indicating the assigned portion) at the mapping table 109. In some embodiments, the security module 104 also determines port numbers (e.g., PCIe port numbers assigned to the VM for one or more I/O devices and stores the port numbers at the mapping table 109.

In addition, in some embodiments, the processor 101 is configured to communicate with I/O devices, such as the I/O device 108, via a plurality of encrypted data streams, such as PCIe Integrity and Data Encryption (IDE) data streams. Each of these encrypted data streams is assigned a corresponding stream identifier, according to the communication protocol (e.g., the PCIe protocol) that governs communication between the processor 101 and the I/O devices. The security module 104 determines the encrypted stream identifiers assigned to each VM to communicate with the corresponding I/O devices and stores the encrypted stream identifiers at the mapping table 109.

In response to receiving an MMIO request, the MMIO security 118 determines (e.g., based on a field of the MMIO request) the VM that is associated with the request. For example, in some embodiments each MMIO request includes a VM identifier (e.g., a VMID) indicating the VM which initiated the MMIO request has been issued. The MMIO security 118 determines, based on the mapping table 109, whether the MMIO request targets a memory address that is within the set of memory addresses assigned to the VM, as indicated by the mapping table 109.

To illustrate, in some embodiments, the MMIO request indicates the virtual addresses that are to be read, that are to be written, or a combination thereof. The MMIO security 118 compares the virtual addresses indicated by the MMIO request and determines if the virtual addresses are within the set assigned to the corresponding VM, as indicated by the mapping table 109. If the virtual addresses fall outside of the VM's assigned set of addresses, or if the mapping of the virtual address is not valid, the MMIO security 118 prevents execution of the MMIO request, such as by halting, or not initiating, translation of the virtual addresses to a set of physical addresses. If the virtual addresses indicated by the MMIO request are within the VM's assigned set of memory addresses (and any other security checks are passed), the MMIO security 118 executes the MMIO request. In some embodiments, the IOMMU 110 (or other circuitry) translates the virtual address targeted by the MMIO request to a physical address, and compares the physical address to a set of physical addresses assigned to the corresponding VM. The MMIO security 118 thus ensures that an MMIO request is only satisfied if the MMIO request targets a memory address (either virtual or physical) that is assigned to the VM and the mapping of the virtual address to a physical address is valid. The IOMMU 110 thus prevents a malicious entity from accessing confidential VM information via an MMIO request.

In some embodiments, the MMIO security 118 performs additional security checks and processing for each MMIO request. For example, in some embodiments each MMIO request indicates a port number (e.g., a PCIe port number) targeted by the request. The MMIO security 118 compares the port number of the MMIO request with the port numbers assigned to the VM, as indicated by the mapping table 109. If the port number indicated by the MMIO request is not assigned to the VM (e.g., due to changes in the address mapping of the root ports), the MMIO security 118 prevents execution of the MMIO request. If the port number indicated by the MMIO request is assigned to the VM, and any other security checks are passed, the MMIO security 118 executes the MMIO request.

In some embodiments, in response to determining that all security checks have been passed and the MMIO request is to be executed, the MMIO security 118 selects one of a plurality of encrypted data streams (e.g., PCIe IDE data streams), based on data stream identifiers stored at the mapping table 109. The MMIO security 118 commands the IOMMU 110 to execute the MMIO request using the selected encrypted data stream. Thus, selection of the encrypted data stream for executing MMIO requests is selected by security hardware of the processor 101, rather than by a hypervisor or VM, thereby protecting secure information of a VM from exploitation via an MMIO request.

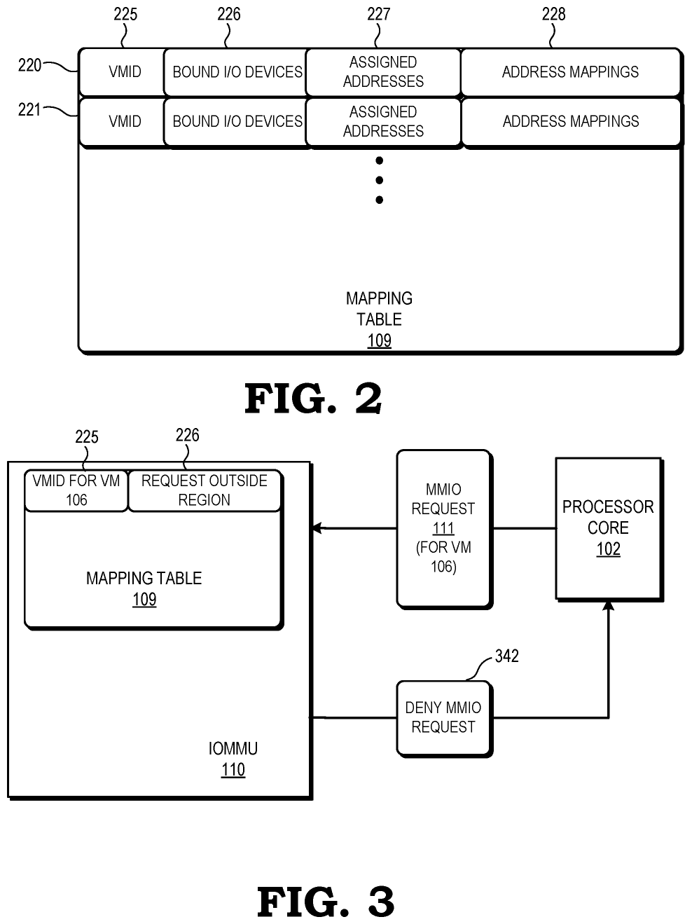

FIG. 2 illustrates an example of the mapping table 109 in accordance with some embodiments. In the depicted example, the mapping table 109 includes a plurality of entries (e.g., entry 220, entry 221), wherein each entry is assigned to a different VM, such as a VM that is currently executing at the processor 101, a VM that has undergone a VM provisioning process at the processing system 100 (and therefore is expected to be executed at the processing system 100 in response to a VMRUN command), and the like, or any combination thereof.

Each entry of the mapping table 109 includes a plurality of fields, including a VM identifier field 225, a bound device field 226, an assigned addresses field 227, and an address mapping field 228. The VM identifier field 225 stores a virtual machine identifier (VMID) assigned (e.g., by the security module 104) to the VM associated with the corresponding entry. That is, the VM identifier field of an entry stores a value, referred to as a VMID, indicating the VM that corresponds to that entry.

The bound device field 226 of an entry stores a value, or set of values, indicating identification information for each I/O device that has been bound to the corresponding VM by the security module 104. For example, in some embodiments, the bound device field stores a root port number, such as a PCIe root port number, indicating a port of the processor 101 associated with the corresponding VM (that is, the port that a request is expected to take in order for the request to reach the device which owns the target MMIO address). In some embodiments, the bound device field 226 also stores a stream identifier (e.g., a PCIe StreamID) that identifies an encrypted data stream between a root port and the corresponding I/O device. In some embodiments, in response to an I/O device successfully completing the specified security process for binding, the security module 104 sends a message to the IOMMU 110 indicating 1) the identification information (e.g., root number) for the I/O device that has been bound; and 2) the VMID for the VM to which the I/O device has been bound. In response, the IOMMU 110 updates the bound device field 226 of the corresponding entry to reflect the indicated information.

The assigned addresses field 227 indicates the set of memory addresses that is assigned to the corresponding VM, including addresses associated with registers or other storage locations of I/O devices (e.g., I/O device 108). In some embodiments, when execution of VM is initiated (e.g., by a VMRUN command), the security module 104 determines the set of memory addresses that is to be assigned to the VM. The security module 104 indicates the assigned set of memory addresses to the IOMMU 110, which stores information indicating the assigned set (e.g., by storing the set of memory addresses indicating the assigned portion) at the assigned addresses field 227 of the corresponding entry of the mapping table 109. The address mapping field 228 stores a set of address mappings for the VM corresponding to the entry of the mapping table 109.

FIG. 3 illustrates an example of the IOMMU 110 using the mapping table 109 to prevent execution of the MMIO request 111 in accordance with some embodiments. In the illustrated example, the IOMMU 110 receives the MMIO request 111 from the processor core 102. The MMIO request 111 includes a request (e.g., a MOV instruction) to either load data from a memory (MMIO) address into a processor register (an MMIO read), or stores data by copying the data from a processor register to an MMIO address (an MMIO write). That is, the processor core 102 indicates, via a field of the MMIO request 111, the memory addresses targeted by the request to read data, write data, or transfer (read and write) data, is on behalf of the VM 106.

In response to receiving the MMIO request 111, the MMIO security 118 accesses the mapping table 109, and in particular the entry of the mapping table 109 that corresponds to the VM 106. The MMIO security 118 then compares the memory addresses indicated by the MMIO request 111 with the memory addresses indicated by the assigned addresses field 227 of the entry of the mapping table 109. In the example of FIG. 3, it is assumed that the memory addresses indicated by the MMIO request 111 fall outside the set of memory addresses stored at the assigned addresses field 227. That is, the MMIO request 111 targets a memory address that has not been assigned to the VM 106. In response to determining that the MMIO request 111 targets a memory address outside the assigned addresses field 227, the MMIO security 118 prevents execution of the MMIO request 111 and notifies the processor core 102 that the MMIO request 111 has been denied by sending a message 342. In some embodiments, the MMIO security 118 also determines, based on the address mapping field 228, whether the address indicated by the MMIO request 111 has a valid mapping. If not, the MMIO security 118 prevents execution of the MMIO request 111. In some embodiments, the MMIO security 118 also checks, for each MMIO request, whether a port number associated with the request matches a port number assigned to the VM, as indicated by the mapping table 109. If the port number does not match a port number assigned to the VM, the MMIO security 118 denies (e.g., aborts) the MMIO request.

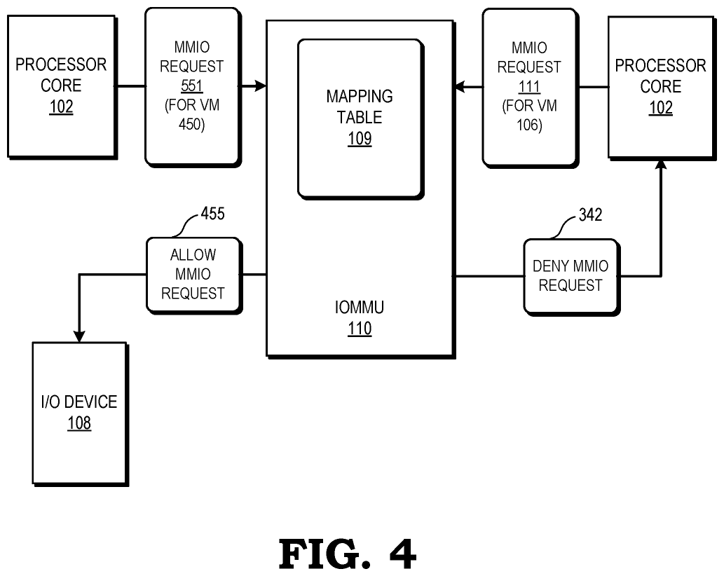

As noted above, the mapping table 109 stores individual entries for each VM that is executing at the processor 101. This allows the IOMMU 110 to allow or deny MMIO requests for different VMs on an individual basis, independent of the MMIO requests for other VMs. An example is illustrated at FIG. 4 in accordance with some embodiments. For the example of FIG. 4, it is assumed that the processor 101 is executing two different VMs: the VM 106 and a VM 450. The IOMMU 110 receives the MMIO request 111 from the processor core 102, indicating a request to access a register or other storage location of an I/O device on behalf of the VM 106. It is further assumed that the mapping table 109 indicates that the MMIO request 111 targets a memory address that has not been assigned to the VM 106. Accordingly, the MMIO security 118 prevents execution of the MMIO request 111 and indicates (via the message 342) that the MMIO request 111 has been denied.

With respect to the MMIO request 451, it is assumed that the mapping table 109 indicates that that the MMIO request 451 targets a memory address that has been assigned to the VM 550. Accordingly, the MMIO security 118 determines that the MMIO request 451 is allowed (as indicated by a message 455), and therefore the IOMMU 110 executes the MMIO request 451. In some embodiments, the MMIO security 118 selects, based on a stream identifier stored at the mapping table 109, an encrypted data stream to execute the MMIO request 111. Thus, in the example of FIG. 4, the MMIO security 118 selectively allows some MMIO requests and denies others, thus preventing a malicious actor from halting or slowing execution of multiple VMs at the processing system 100 by issuing an improper MMIO request.

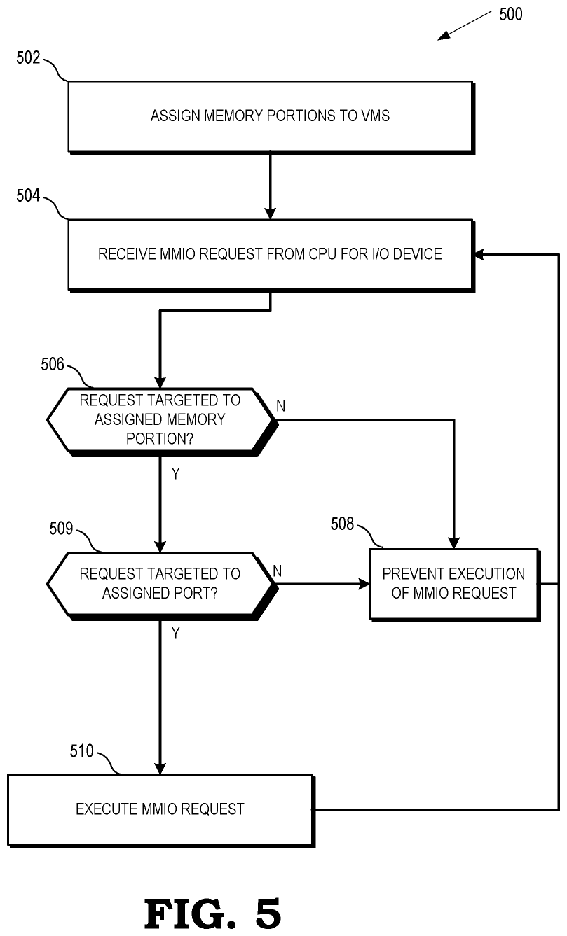

FIG. 5 illustrates a flow diagram of a method 500 of managing secure MMIO accesses at an IOMMU in accordance with some embodiments. For purposes of description, the method 500 is described with respect to an example implementation at the processing system 100 of FIG. 1, but it will be appreciated that in other embodiments the method 500 is implemented at processing systems having different configurations. At block 502, the security module 104 binds one or more I/O devices to the VM 106 according to a specified security process, such as a Trusted Execution Environment (TEE) Device Interface Secure Protocol (TDISP) process. For example, in some embodiments the processing system 100 includes a communication fabric (not shown) that complies with a Peripheral Component Interconnect Express (PCIe) communication protocol. In particular, I/O devices such as I/O device 108, are configured to communicate with the processor 101, and the IOMMU 110, according to the PCIe communication protocol. In some embodiments, the PCIe communication protocol establishes a TDISP security registration process for binding I/O devices to VMs, and the security module 104 uses the TDISP security registration process to bind I/O devices to executing VMs. In addition, at block 502 the security module 104 assigns sets of memory addresses to respective executing VMs. The security module 104 programs the mapping table 109 to store indications of the I/O devices bound to each VM, such as by storing port numbers (e.g., PCIe port numbers) assigned to each VM, and the set of memory addresses assigned to each VM. In some embodiments, the security module 104 also determines the encrypted communication streams (e.g., PCIe IDE streams) assigned to each VM, and stores stream identifiers for the assigned communication streams at the mapping table 109.

At block 504, the IOMMU 110 receives the MMIO request 111 from the I/O device 108. The MMIO request 111 includes an identifier of the VM associated with the request and address information indicating the memory addresses targeted by the request. At block 506, the MMIO security 118 determines whether the MMIO request 111 targets memory addresses that are assigned to the corresponding VM. If not, the method flow moves to block 508 and the IOMMU 110 prevents execution of the MMIO request 111. The method flow then returns to block 504.

If, at block 506, the MMIO security 118 determines that the MMIO request 111 does target memory addresses that are assigned to the corresponding VM, the method flow moves to block 509 and the MMIO security 118 determines whether the port number indicated by the MMIO request 111 matches a port number assigned to the corresponding VM, as indicated by the mapping table 109. For example, in some embodiments The port targeted by the MMIO request (e.g., a PCIe port) is selected based upon the physical MMIO address. That is, each port is associated with a range of physical addresses. The MMIO security checks that the port number selected based upon the physical address matches the port number identified in the mapping table entry corresponding to the same physical address. If not, the method flow moves to block 508 and the IOMMU 110 prevents execution of the MMIO request 111. The method flow then returns to block 504. In some embodiments, the port number isn't exclusively assigned to the VM. For example, in some embodiments a single PCIe port supports MMIO requests belonging to multiple VMs all targeting different MMIO address ranges on an I/O device (e.g., MMIO belonging to different virtual functions).

If, at block 509, the MMIO security 118 determines that the port number indicated by the MMIO request matches a port number assigned to the corresponding VM, the method flow moves to block 510 and the MMIO security 118 selects, based on the mapping table 109, an encrypted data stream. The MMIO security 118 commands the IOMMU to execute the MMIO request 111 using the selected encrypted data stream. The method flow then returns to block 504.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to receiving a first memory mapped input/output (MMIO) request associated with a first virtual machine (VM), identifying whether the first MMIO request is targeted to at least one of a set of memory addresses assigned to the first VM; and
preventing, execution of the first MMIO request responsive to identifying that the first MMIO request is targeted to a memory address outside the set of memory addresses assigned to the first VM.

2. The method of claim 1, further comprising:
in response to receiving, from a second device, a second MMIO request associated with the first VM, identifying whether the second MMIO request is targeted to the set of memory addresses assigned to the first VM; and
executing, at an input/output memory management unit (IOMMU), the second MMIO request responsive to identifying that the second MMIO request is targeted to the set of memory addresses assigned to the first VM.

3. The method of claim 1, further comprising:
receiving the set of memory addresses assigned to the first VM from a security coprocessor of a processor configured to execute the first VM.

4. The method of claim 1, further comprising:
preventing execution of the first MMIO request responsive to identifying that the first MMIO request is targeted to a port number not assigned to the set of memory addresses.

5. The method of claim 1, further comprising:
in response to receiving, from a second device, a second MMIO request associated with a second VM, identifying whether the second MMIO request is targeted to at least one of a set of memory addresses assigned to the second VM; and
preventing execution of the second MMIO request responsive to identifying that the second MMIO request is targeted to a memory address outside the set of memory addresses assigned to the second VM.

6. The method of claim 1, wherein the MMIO request targets an input/output device.

7. The method of claim 1, further comprising:
responsive to identifying that the first MMIO request is targeted to a memory address assigned to the first VM, selecting an encrypted data stream to execute the first MMIO request.

8. A method comprising:
preventing, execution of a first MMIO request for a first virtual machine (VM) responsive to the first MMIO request being targeted to at least one memory address outside of a first set of memory addresses assigned to the first VM.

9. The method of claim 8, further comprising:
executing, at an input/output memory management unit (IOMMU), a second MMIO request for the first VM responsive to the second MMIO request being targeted to at least one memory address of the first set of memory addresses assigned to the first VM.

10. The method of claim 9, further comprising:
preventing execution of a third MMIO request for a second virtual machine (VM) responsive to the third MMIO request being targeted to at least one memory address outside of a second set of memory addresses assigned to the second VM.

11. The method of claim 8, further comprising:
preventing, execution of the first MMIO request for a first virtual machine (VM) responsive to the first MMIO request being targeted to a communication port not assigned to the first VM.

12. The method of claim 8, further comprising:
receiving the first set of memory addresses assigned to the first VM from a security coprocessor of a processor configured to execute the first VM.

13. The method of claim 8, further comprising:
determining the first set of memory addresses assigned to the first VM based on a mapping table mapping addresses associated with the first VM.

14. The method of claim 13, wherein the mapping table is cached at an IOMMU.

15. A processor comprising:
an input/output memory management unit (IOMMU); and
security hardware configured to:
in response to receiving a first memory mapped input/output (MMIO) request associated with a first virtual machine (VM), identify whether a first MMIO request is targeted to at least one of a set of memory addresses assigned to the first VM; and
prevent execution of the first MMIO request responsive to identifying that the first MMIO request is targeted to a memory address outside the set of memory addresses assigned to the first VM.

16. The processor of claim 15, wherein the security hardware is configured to:
in response to receiving, from a second device, a second MMIO request associated with the first VM, identify whether the second MMIO request is targeted to the set of memory addresses assigned to the first VM; and
execute the second MMIO request responsive to identifying that the second MMIO request is targeted to the set of memory addresses assigned to the first VM.

17. The processor of claim 15, wherein the security hardware is configured to:
receive the set of memory addresses assigned to the first VM from a security coprocessor of the processor.

18. The processor of claim 15, wherein the security hardware is configured to:
prevent execution of the first MMIO request responsive to identifying that the first MMIO request is targeted to a port number not assigned to the set of memory addresses.

19. The processor of claim 15, wherein the security hardware is configured to:
in response to receiving, from a second device, a second MMIO request associated with a second VM, identify whether the second MMIO request is targeted to at least one of a set of memory addresses assigned to the second VM; and
prevent execution of the second MMIO request responsive to identifying that the second MMIO request is targeted to a memory address outside the set of memory addresses assigned to the second VM.

20. The processor of claim 15, wherein the security hardware is configured to:
responsive to identifying that the first MMIO request is targeted to a memory address assigned to the first VM, select an encrypted data stream to execute the first MMIO request.
